(19) United States
(12) Patent Application Publication
(10) Pub. No.: US 2011/0109557 A1
(43) Pub. Date: May 12, 2011

(54) Automatic Enablement And Disablement Of A Cursor Mover

(76) Inventors: Luca Di Fiore, Taipei (TW); Kung-Neng Lee, Taipei (TW)

(21) Appl. No.: 13/003,518

(22) PCT Filed: Jul. 11, 2008
(86) PCT No.: PCT/US2008/069830

§ 371 Date: Jan. 10, 2011

(51) Int. Cl. G06F 3/02

(52) U.S. Cl. 345/168

(57) ABSTRACT

A computer system includes a keyboard having at least one cursor mover, and at least one sensor. The sensor can detect whether a hand is near the sensor. When the sensor fails to detect a hand near the sensor, at least one cursor mover is enabled.

### DESCRIPTION OF THE RELATED ART

Keyboards for computers, and in particular keyboards for portable computers, commonly have a cursor mover (touch pad and/or cursor control switches) for moving the position of a cursor on a display. Typically, moving a finger on the cursor mover causes the cursor on a display to move, and pressing or tapping the cursor mover causes the point of data entry (the insertion point) to move to the cursor location. If the operator accidently touches the cursor mover during typing, the cursor and insertion point may be moved, resulting in text or data being entered at an unexpected location. The operator must then delete or move the wrongly located text or data, and reposition the insertion point.

A cursor mover can typically be enabled and disabled through a control menu, or a manually controlled electronic switch. Disabling and enabling through a control menu or manual switch requires significant time relative to the time required to pause and move the insertion point. It is also known to automatically disable a cursor mover during active use of alphanumeric or typographic keys on a keyboard, and to automatically enable the cursor mover when the other keyboard activity is paused (see, for example, U.S. Published Application Number 2002/0180704). There is a need for alternative ways of automatically enabling and disabling a touch pad or cursor control switch.

### BRIEF DESCRIPTION OF THE DRAWINGS

FIG. 1 is a block diagram illustrating an example embodiment of a keyboard.

FIG. 2 is a flow chart illustrating an example embodiment of a method for automatic enablement and disablement of a cursor mover.

### DETAILED DESCRIPTION

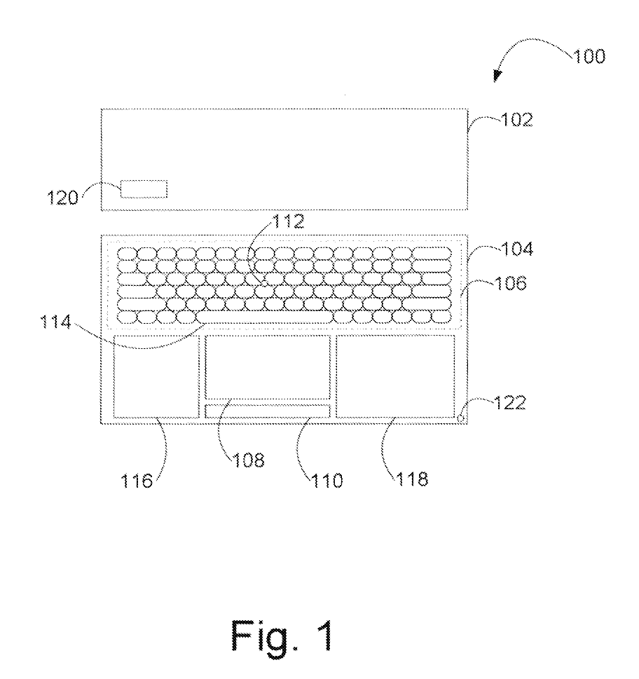

FIG. 1 illustrates an example computing system 100. including a computing device 102 and a keyboard 104. The keyboard may be attached to the computing device (for example, a laptop, notebook, or tablet computer), or may be connected to the computing device by a cable, or it may be wirelessly connected. The computing device may be a general purpose computer, or a specialized device such as a gaming console, instrument controller, point-of-sale terminal, etc. The keyboard includes keys 106 for entry of alphanumeric data and keys for entry of typographic functions (for example. tab, space, backspace. etc.). In addition to the alphanumeric and typographic keys, the keyboard includes at least one cursor mover. One example of a cursor mover is a touch pad 108 with an associated switch 110. Switch 110 provides the same function as a button switch on a computer mouse. An alternative (or additional) example cursor mover is a switch 112 within the alphanumeric key area that functions similarly to a “joy stick”. That is, pressing the switch in a direction parallel to the surface of the keyboard causes the cursor to move in the direction the switch is being pressed, and pressing the switch into the keyboard activates a switch for the same function as a button switch on a computer mouse. Still another example of a cursor mover is a multi-function alphanumeric or typographic key. For example, in one mode, a space bar 114 may act simply as a key for entering a typographic function space, but in another mode the space bar may be moved like a joy stick, or rolled like a scrolling wheel, or otherwise used to control the position of a cursor on a display. Other examples include trackballs, rotating wheels. scroll bars, and arrow keys.

Keyboard 104 also includes sensors (116, 118) used to detect the proximity of a human hand. The sensor areas are within areas also used for palm rests when typing. The sensors may detect actual touch (palms resting on the palm rest areas), or may detect that a hand is near but not touching. When an operator is using the keyboard in a touch-typing position, the fingers are touching alphanumeric or typographic keys, and the palms of the hands are resting on the sensors 116 and 118, or are positioned just above the sensors, typically closer than about 4 cm. vertically from the surface of the sensors. When an operator wants to move the cursor on a display. at least one hand is positioned to place a finger on a cursor mover, moving most of the palm of that hand further away from the sensors 116 and 118. If all sensors detect a hand nearby, at least one cursor mover is disabled. If at least one of the sensors detects that at least one hand has moved away from the sensor, then at least one cursor mover is enabled. Preferably, only cursor movers subject to accidental touching while typing are disabled, and any cursor movers not subject to accidental touching while typing (for example. a separate computer mouse) are left enabled.

In the above example, two sensors are used to detect whether either hand is moved away from the sensor area. Alternatively, it may be suitable to detect proximity of only a single hand. For example, a single sensor may detect the proximity of the right hand, and any time the right hand is moved away from the sensor then various cursor movers are enabled.

There are many technologies suitable for detecting proximity. For example, sensors 116 and 118 may passively sense infrared heat from hands, or they may emit light and detect light reflected from a hand, or they emit light pulses and measure time of flight of light to a hand and back to the sensor, or they emit sound and measure time of flight of sound to a hand and back to the sensor, or they may measure a change in capacitance resulting from the presence of a hand within an electric field. In one example embodiment, the keyboard includes a commercially available sensor integrated circuit (QT1081, available from Quantum Research Group, 1 Mitchell Point, Ensign Way, Hamble SO31 4RF, Great Britain). The QT1081 sensor IC employs capacitive sensing, and the sensing electrode can be a solid shape such as the rectangular areas depicted by sensors 116 and 118 in FIG. 1.

Use of the sensors for automatic enabling and disabling a cursor mover does not preclude other additional alternative controls, such as a hardware switch, or a software switch, or other controls to enable/disable one or more cursor movers. In addition, an alternative hardware switch or software switch may be used to enable and disable the automatic system using the sensors. Software/firmware to detect the sensor outputs, and to enable or disable a cursor mover, and to enable or disable the system using the sensors, may be implemented in the computing device, or may be implemented in a processor or ASIC in the keyboard. In FIG. 1, element 120 depicts software/firmware in the computing device used to enable/disable the palm sensing system, and to enable/disable one or more cursor movers when the palm sensing system is enabled. In FIG. 1, element 122 depicts an optional hardware switch that may be used to enable/disable the palm sensing system, or may be used as an alternative switch to enable/disable one or more cursor movers.

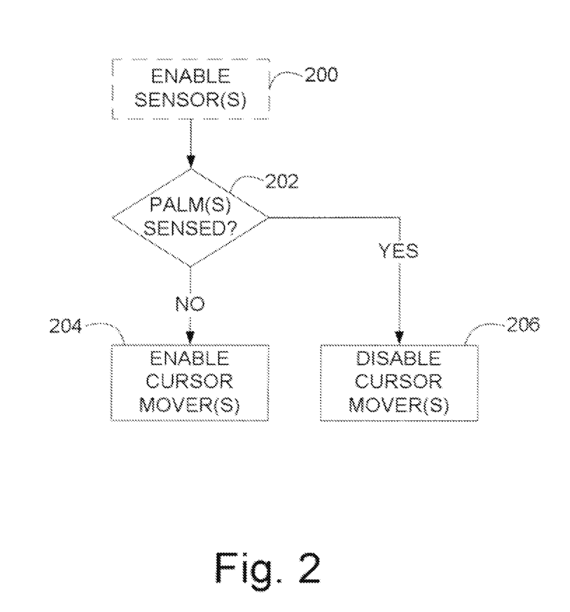

FIG. 2 is a flow chart illustrating an example method for automatically enabling and disabling a cursor mover. At optional step 200, at least one palm sensor is enabled (for example, via software/firmware in the computing device or keyboard, or via a hardware switch). At step 202, the system determines whether the palm sensor(s) detect that a palm is not nearby. When at least one palm is away from the sensor(s), then at step 204 at least one cursor mover is enabled. Otherwise, at step 206 at least one cursor mover is disabled.

What is claimed is:

1. A computer system, comprising:
a keyboard having at least one cursor mover;
at least one sensor on the keyboard, the sensor configured to detect the presence of a hand near the sensor;
the computer system configured to disable the cursor mover when the sensor detects a hand near the sensor, and configured to enable the cursor mover when the sensor does not detect a hand near the sensor.

2. The computer system of claim 1, wherein the sensor is configured to detect a hand contacting the sensor.

3. The computer system of claim 1, wherein the sensor is configured to detect a hand closer than 4 centimeters from the sensor.

4. The computer system of claim 1, further comprising:
firmware to enable and disable the sensor.

5. The computer system of claim 1, further comprising:
a hardware switch to enable and disable the sensor.

6. The computer system of claim 1, wherein the cursor mover is a touchpad.

7. The computer system of claim 1, further comprising:
at least two sensors on the keyboard, each sensor configured to detect the presence of a hand near the sensor;
the computer system configured to disable the cursor mover when the sensors detect more than one hand near the sensors, and configured to enable the cursor mover when the sensors detect fewer than two hands near the sensors.

8. A method, comprising:
determining, by at least one sensor, whether a hand is near the sensor;
disabling at least one cursor mover when the sensor determines that a hand is near the sensor; and
enabling at least one cursor mover when the sensor determines that there is no hand near the sensor.

9. The method of claim 8, further comprising:
enabling, by firmware, the sensor.

10. The method of claim 8, further comprising:
enabling, by a hardware switch, the sensor.

11. The method of claim 8, further comprising:
determining, by a plurality of sensors, whether more than one hand is near the sensors;
disabling at least one cursor mover when the sensors determine that more than one hand is near the sensors; and
enabling at least one cursor mover when the sensors determine that fewer than two hands are near the sensors.

12. A computer system, comprising:
means for detecting a hand near a keyboard; and
means for enabling at least one cursor mover when the means for detecting does not detect a hand near the keyboard.
